(19) United States
(12) Patent Application Publication
(10) Pub. No.: US 2014/0333746 A1
(43) Pub. Date: Nov. 13, 2014

(54) METHOD AND APPARATUS FOR INQUIRING INFORMATION

(71) Applicant: TENCENT TECHNOLOGY (SHENZHEN) COMPANY LIMITED, Shenzhen (CN)

(72) Inventors: Daxi Huang, Shenzhen (CN); Yun Jia, Shenzhen (CN); Zhenwei Zhang, Shenzhen (CN); Ling Wang, Shenzhen (CN)

(73) Assignee: TENCENT TECHNOLOGY (SHENZHEN) COMPANY LIMITED, Shenzhen (CN)

(21) Appl. No.: 14/341,062

(22) Filed: Jul. 25, 2014

Related U.S. Application Data
(63) Continuation of application No. PCT/CN2014/071271, filed on Jan. 23, 2014.

(30) Foreign Application Priority Data
Feb. 6, 2013 (CN) 201310046415.8

(51) Int. Cl. G06F 17/30; G06K 9/00

(52) U.S. Cl. CPC G06F 17/30277; G06K 9/00221; G06K 9/00268
USPC 348/77

(57) ABSTRACT

A method and an information inquiring apparatus is provided. The method includes: acquiring facial image of a target user to be inquired when receiving query information request; querying social network service information of the target user matching with the facial image, based on the facial image of the target user; and outputting social network service information of the target user. The method and the information inquiring apparatus are configured to increase efficiency of information queries and improve intelligence of the SNS application.

### CROSS REFERENCE TO RELATED APPLICATIONS

This application is a U.S. continuation application under U.S.C. §111(a) claiming priority under U.S.C. §§120 and 365(c) to International Application No. PCT/CN2014/071271, entitled “METHOD AND APPARATUS FOR INQUIRING INFORMATION”, filed on Jan. 23, 2014, which claims priority to Chinese Patent Application No. 201310046415.8, entitled “METHOD AND APPARATUS FOR INQUIRING INFORMATION” and filed on Feb. 6, 2013, both of which are hereby incorporated in their entireties by reference.

### FIELD OF THE TECHNICAL

The present disclosure relates to internet technology, such as Social Networking Service (SNS), and to a method and an information inquiring apparatus.

### BACKGROUND

This section provides background information related to the present disclosure which is not necessarily prior art.

With development of SNS technology, users can take advantage of SNS application platform to exchange information with other users. In traditional social network service, if the users want to obtain other users' SNS information, they need to know some basic information about a target user, such as the target user's name, address, etc. And the user searches manually for more complete SNS information of the target user in a SNS application by using the basic information. However, the above method requires basic information inputted manually, resulting in inefficiency of information inquiry. In addition, in most cases, the user may not know the target user's basic information, or the basic information the user obtained is incorrect. In that case, effective information queries cannot be achieved, reducing intelligence of the SNS application.

### SUMMARY

This section provides a general summary of the disclosure, and is not a comprehensive disclosure of its full scope or all of its features.

The embodiments of the present disclosure provide a method and an information inquiring apparatus. The method and the information inquiring apparatus are directed to solve one or more problems set forth above and other problems, so that efficiency of information queries can be increased, and intelligence of the SNS application can be improved.

The technical solutions provided by the embodiments of the present disclosure include the following.

A method for inquiring information includes:

acquiring facial image of a target user to be inquired when receiving query information request;

querying social network service information of the target user matching with the facial image, based on the facial image of the target user;

outputting social network service information of the target user.

An information inquiring apparatus, includes:

acquiring module, configured for acquiring facial image of a target user to be inquired when receiving query information request;

querying module, configured for querying social network service information of the target user matching with the facial image, based on the facial image of the target user; and

outputting module, configured for outputting social network service information of the target user.

An information inquiring apparatus, includes:

memory;

one or more processors; and

one or more modules stored in the memory and configured for execution by the one or more processors, the one or more modules including instructions:

to acquire facial image of a target user to be inquired when receiving query information request;

to query social network service information of the target user matching with the facial image, based on the facial image of the target user; and

to output social network service information of the target user.

As can be seen from the above technical solutions, according to the embodiments of the present disclosure, the above method and information inquiring apparatus are configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a flowchart illustrating an exemplary method for inquiring information, in accordance with various embodiments.

FIG. 2 is a flowchart of another exemplary method for inquiring information, in accordance with various embodiments.

FIG. 3 is a flowchart of another exemplary method for inquiring information, in accordance with various embodiments.

FIG. 4A is a schematic view of an exemplary method for inquiring information accordance with various embodiments.

FIG. 4B is a schematic view of another exemplary method for inquiring information in accordance with various embodiments.

FIG. 5 is a block diagram of an apparatus, in accordance with various embodiments.

FIG. 6 is a block diagram of an apparatus, in accordance with various embodiments.

FIG. 7 is a block diagram of an acquiring module of an apparatus, in accordance with various embodiments.

FIG. 8A is a block diagram of a querying module of an apparatus, in accordance with various embodiments.

FIG. 8B is a block diagram of a querying module of an apparatus, in accordance with various embodiments.

Corresponding reference numerals indicate corresponding parts throughout the several views of the drawings.

### DETAILED DESCRIPTION OF ILLUSTRATED EMBODIMENTS

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

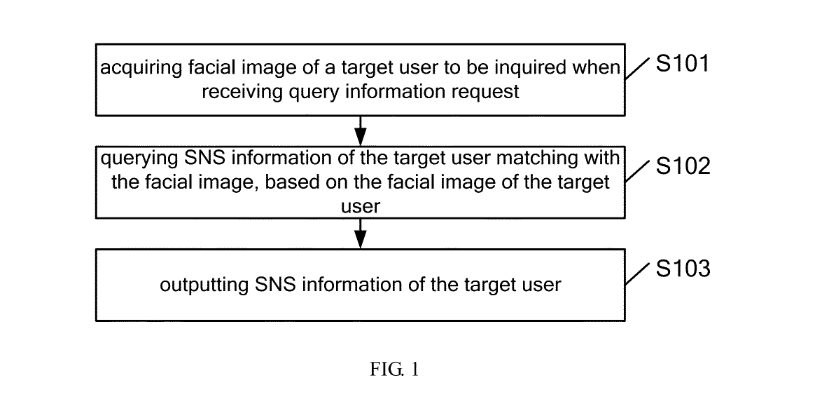

Referring to FIG. 1, a method for inquiring information in a first embodiment is provided. The method includes steps S101 to S103.

Step S101, acquiring facial image of a target user to be inquired when receiving query information request.

In this embodiment, users can initiate a query information request in an SNS application, if they want to inquire information of the target user. In this embodiment, the SNS application may include, but not limited to personal spaces, interactive websites, forums and other applications. In one embodiment, the user can click on a query information button of an application, or the user can select a certain item in a query information list. In step S101, facial image of a target user to be inquired is acquired when receiving query information request.

Step S102, querying social network service (SNS) information of the target user matching with the facial image, based on the facial image of the target user.

In this embodiment, the SNS information may include, but not limited to SNS registration information and/or SNS functional information. The SNS registration information may represent identity of the target user. The SNS registration information includes but not limited to one of the at least: a name registered in the SNS application, an address information registered in the SNS application, a time information registered in the SNS application, etc. In this embodiment, the SNS functional information may represent social activities of the target user. The SNS functional information includes, but not limited to one of the at least: album information of the SNS application, game information of the SNS application, music information of the SNS application, etc.

Step S103, outputting SNS information of the target user.

In this step, SNS information of the target user is outputted. In this way, the user knows identity of the target user or social activities of the target user.

According to the FIG. 1, the above method for inquiring information is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired.

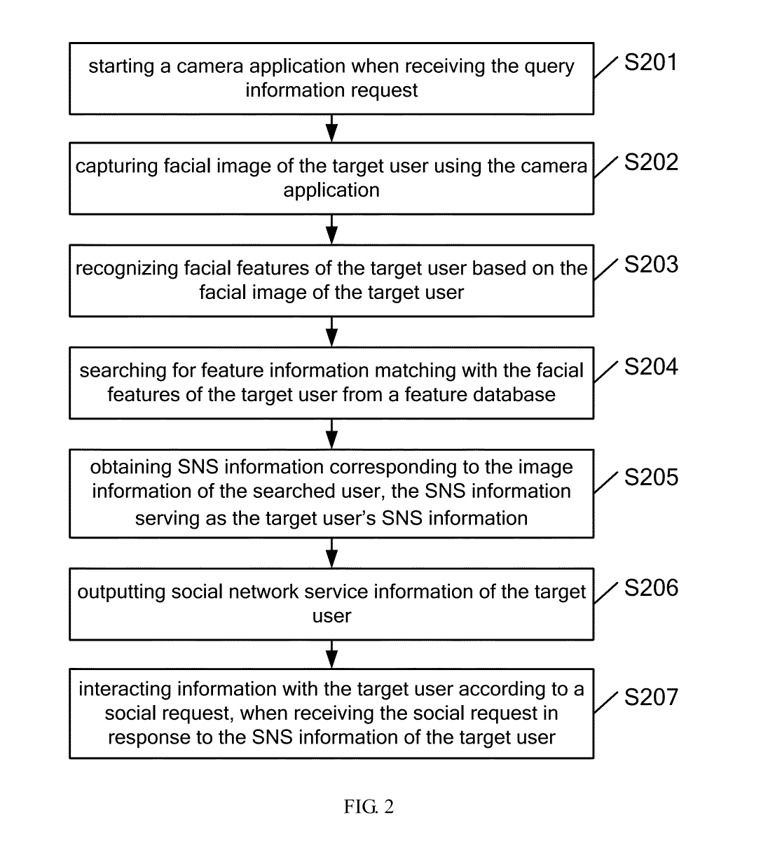

Referring to FIG. 2, a method for inquiring information in an embodiment is provided. The method includes steps of S201 to S207.

Step S201, starting a camera application when receiving the query information request.

In this embodiment, users can initiate a query information request in an SNS application, if they want to inquire information of the target user. In one embodiment, the user can click on a query information button of an application, or the user can select a certain item in a query information list. Fox example, if a camera module is embedded in a device (i.e. an information inquiring apparatus), then a corresponding camera application is initiated when the query information request is detected. In this embodiment, the information inquiring apparatus is a mobile phone, and a camera module is built-in component of the mobile phone. When the query information request initiated by the user is detected, the corresponding camera application is started. In alternative embodiments, a camera module is not built in the apparatus. Instead, an external camera is connected to a personal computer (PC). In this case, when the query information request initiated by the user is detected, the external camera is started.

Step S202, capturing facial image of the target user using the camera application. In this embodiment, a facial image of the target user is captured by the camera (module) mentioned in step S202. In addition, the facial image can be dynamic image or static image.

Step S203, recognizing facial features of the target user based on the facial image of the target user.

In this embodiment, human face recognition technology can be configured to recognize facial features of the target user, based on the facial image of the target user.

In a feasible embodiment, the above mentioned recognizing step can be executed by using feature vector method, based on human face recognition technology. The method firstly determines size, location, distance and other characteristics of iris, nose, mouth and other facial features. Then a feature vector of each characteristic is calculated. Amount of the geometric properties of each characteristic constitutes the facial feature vector of the target user, which is configured to describe facial characteristics of the target user.

In another possible embodiment of the present disclosure, the above mentioned recognizing step can be executed by using Face print technology. In this embodiment, a face print file is formed by using sampling and a series of quantization processing based on the target user's facial image. Then a number of face print codes is generated by using the face print file. The face print codes can reflect the target user's facial features. By using the face print codes, shortage of light, skin color, facial hair, hair, glasses, facial expressions and gestures can be eliminated, resulting in high reliability.

It is noted, other methods of human face recognition technology can be configured to recognize facial features. For example, auto correlation pattern recognition using network or combination of features and template, etc. can also be configured to recognize facial features of the target user.

Step S204, searching for feature information matching with the facial features of the target user from a feature database.

In this step S204, the feature database stores at least one user's feature information, and the SNS information corresponding to the feature information of each user. In this embodiment, the feature information of the user refers to information for describing facial feature of the user, includes: feature vectors of the facial image related to the user, and/or face print codes of the user. In addition, the feature information of the user is related to the SNS information of the user. In other words, the SNS information of the user can be searched by using the feature information of the user. In contrary, the feature information of the user can be searched by using the SNS information of the user. In this embodiment, by using the facial feature of the target user, the feature information corresponding to the facial feature of the target user can be searched in the feature database. In particular, if the feature information corresponding to the facial feature of the target user can be searched in step S204, then step S205 is executed. In contrary, if the feature information corresponding to the facial feature of the target user cannot be searched, then tips can be displayed to remind query fails.

In this step S205, obtaining SNS information corresponding to the image information of the searched user, the SNS information serving as the target user's SNS information.

As described above, the feature database stores at least one user's feature information, and the SNS information corresponding to the feature information of each user. By using the facial feature of the target user, the feature information corresponding to the facial feature of the target user can be searched in the feature database. And the SNS information of the user can be searched by using the feature information of the user. The SNS information serves as the target user's SNS information.

In step S206, outputting social network service information of the target user.

In this step S206, SNS information of the target user is outputted. In this way, the user knows identity of the target user or social activities of the target user.

In step S207, interacting information with the target user according to a social request, when receiving the social request in response to the SNS information of the target user.

In this embodiment, other users can exchange information with the target user. Fox example, other users can initiate a social request, thus inquiring to add the target user as a friend in the SNS application. In one way, the other user sends a social request to the target user. The social request can be a new friend request configured to add a new friend in the SNS application based on the SNS registration information. In another way, the other user sends a social request to the target user, and the social request can be a new friend request configured to ask the target user for taking in a same social activity in the SNS application. In this embodiment, other user sends an invitation request to the target user, based on other user's social request, and based on SNS functional information of the target user. In this way, the SNS application of the target user responses to the invitation request to execute corresponding constructions.

Referring to FIG. 2, the above method for inquiring information is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired. In addition, other users can exchange information with the target user, based on the SNS information, thus on line and off line social relationships can be enhanced, and intelligence of the SNS application is improved.

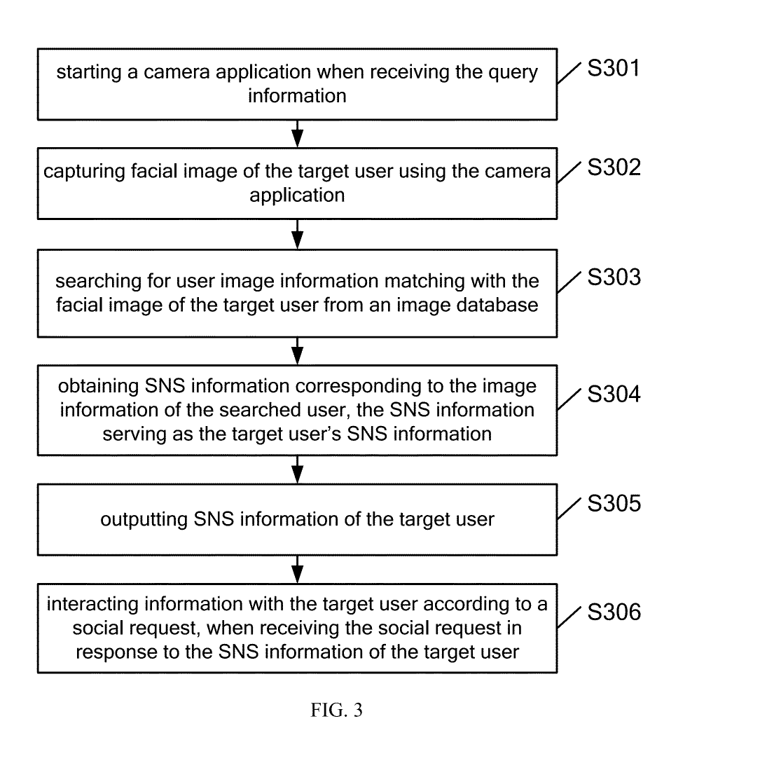

Referring to FIG. 3, a method for inquiring information in an embodiment is provided. The method includes steps of S301 to S306.

Step S301, starting a camera application when receiving the query information.

Step S302, capturing facial image of the target user using the camera application.

Step S303, searching for user image information matching with the facial image of the target user from an image database.

In this step S303, the image database stores at least one user's user image information, and the SNS information corresponding to the user image information of each user. In this embodiment, the image information of the user refers to information for describing facial information of the user, such as image information. The image information of the user is related to the SNS information of the user. In other words, the SNS information of the user can be searched by using the image information of the user. In contrary, the image information of the user can be searched by using the SNS information of the user. In this embodiment, by using the facial image of the target user, the image information corresponding to the facial image of the target user can be searched in the image database, based on the image matching technique. In particular, if the image information corresponding to the facial image of the target user can be searched in step S304, then step S305 is executed. In contrary, if the image information corresponding to the facial image of the target user cannot be searched, then tips can be displayed to remind query fails.

In this step S304, obtaining SNS information corresponding to the image information of the searched user, the SNS information serving as the target user's SNS information.

As described above, the image database stores at least one user's image information, and the SNS information corresponding to the image information of each user. By using the facial image of the target user, the image information corresponding to the facial image of the target user can be searched in the image database. And the SNS information of the user can be searched by using the image information of the user. The SNS information serves as the target user's SNS information.

In step S305, outputting SNS information of the target user.

In step S306, interacting information with the target user according to a social request, when receiving the social request in response to the SNS information of the target user.

In this embodiment, steps 301-302 are similar to respective steps 201-202 shown in FIG. 2, steps 305-306 are similar to respective steps 206-207 shown in FIG. 2, which will not be further described herein.

Referring to FIG. 3, the above method for inquiring information is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired. In addition, other users can exchange information with the target user, based on the SNS information, thus on line and off line social relationships can be enhanced, and intelligence of the SNS application is improved.

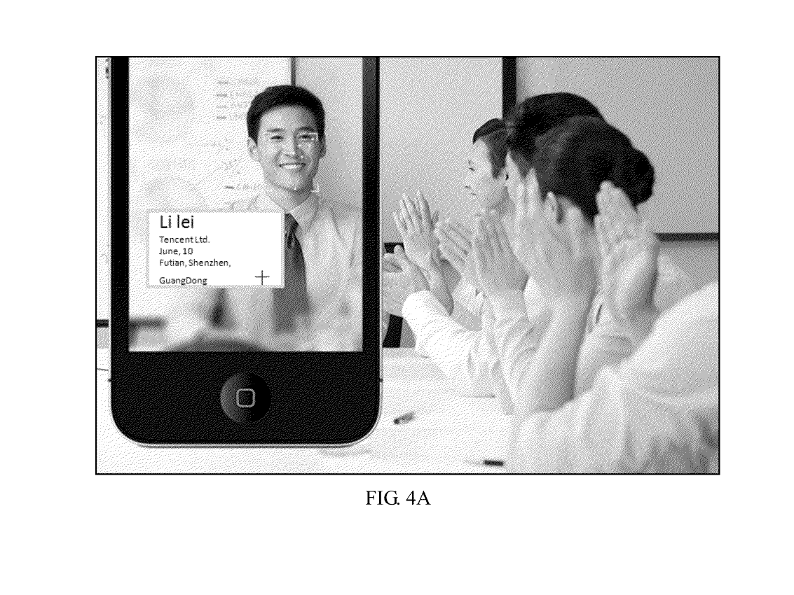

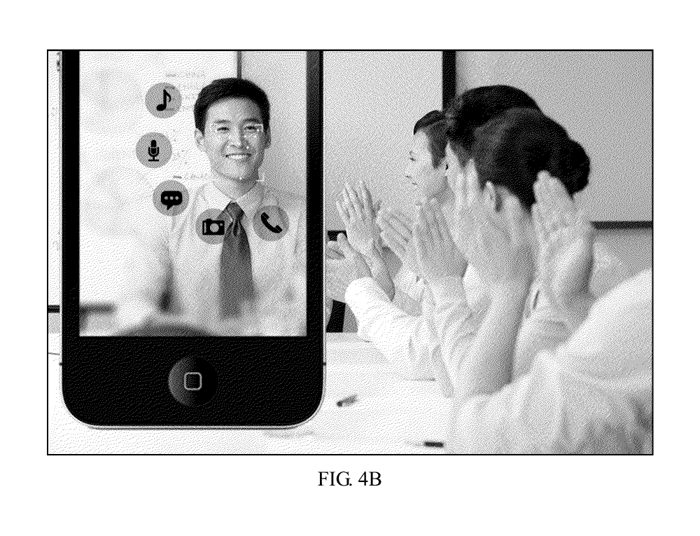

Referring to FIG. 4, an embodiment is shown here to illustrate process of the information inquiring method in the present disclosure. As shown in FIG. 4, the target user is labeled as B, and the user initiate the query information request is labeled as A. A mobile phone A of user A executes the method for inquiring information.

FIG. 4A is a schematic view of an exemplary method for inquiring information, illustrating an embodiment of the present disclosure. As shown in FIG. 4A, if the user A wants to inquire SNS information of the target user B, the query information request can be initiated by an SNS application installed in the mobile phone A. In one embodiment, the user A can click on a query information button of the SNS application, or the user can select a certain item in a query information list of the SNS application. In this way, the mobile phone A starts the camera to capture facial image of the user B, and the mobile phone A can recognize facial features by using the facial image of user B. Then the mobile phone A searches for feature information matching with the facial features of the user B from a feature database, and further obtains SNS information corresponding to the image information of the user B. The obtained SNS information serves as the user B's SNS information. As shown in FIG. 4A, the mobile phone A shows SNS information of the user B.

FIG. 4B is a schematic view of another exemplary method for inquiring information, illustrating an embodiment of the present disclosure. As shown in FIG. 4B, the SNS application of the mobile phone A provides information interacting list. If the user A wants to interact information with the user B, the user A can select a certain item in the information interacting list. In this way, the user A initiates a social request. Fox example, the user A can select an item “new friend” in the information interacting list to initiate the social request, asking for adding the user B as a SNS friend. Accordingly, the mobile phone initiates such “new friend” request toward user B, based on the social request of user A, and also using SNS registration information of user B.

According to the embodiment of the present disclosure, the above method for inquiring information is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired. In addition, other users can exchange information with the target user, based on the SNS information, thus on line and off line social relationships can be enhanced, and intelligence of the SNS application is improved.

In the present disclosure, an information inquiring apparatus is provided to execute steps of the method for inquiring information, as shown in FIG. 1 to FIG. 4. The information inquiring apparatus may be in the form of two following feasible embodiments. In the first feasible embodiment, the information inquiring apparatus is an independent integrated device for execute all the steps shown in FIG. 1 to FIG. 4, thus achieving information inquiry. In this embodiment, the information inquiring apparatus can be a client or a server, or a terminal embedded in the client or the server.

In the FIG. 2, the information inquiring apparatus includes a first configuration device and a second configuration device. The first configuration device and the second configuration device cooperate to execute all the steps shown in FIG. 1 to FIG. 4, thus achieving information inquiry. In this embodiment, the first configuration device can be a client or a functional module configured in the client, and the second configuration device can be a server or a functional module configured in the server.

In this embodiment, the client may include, but not limited to personal computer PC, mobile phone, smart phone, tablets, e-reader, laptop and other device.

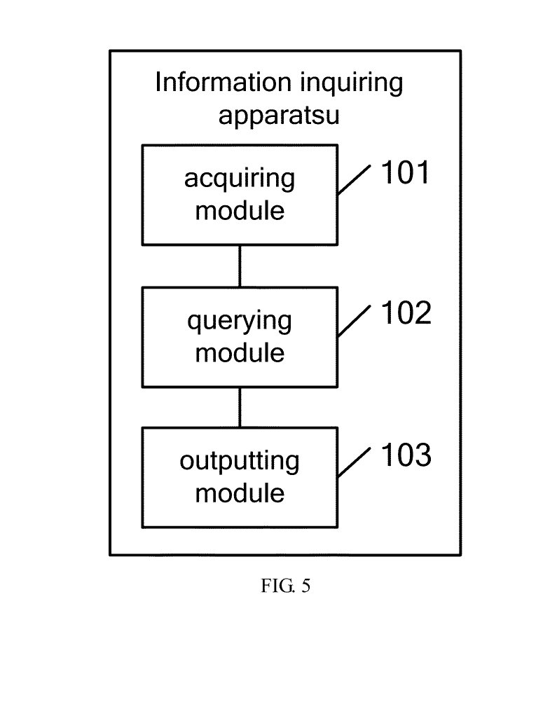

Referring to FIG. 5 to FIG. 8, structure of the information inquiring apparatus can be described in details as follow.

FIG. 5 is a schematic view of an information inquiring apparatus, in accordance with an exemplary embodiment. The apparatus includes an acquiring module 101, a querying module 102, and an outputting module 103.

In this embodiment, users can initiate a query information request in an SNS application, if they want to inquire information of the target user. For example, the user can click on a query information button of an application, or the user can select a certain item in a query information list. Overall, the acquiring module 101 is configured to acquire facial image of a target user to be inquired when receiving query information request.

The querying module 102 is configured to query SNS information of the target user matching with the facial image, based on the facial image of the target user.

In this embodiment, the SNS information may include but not limited to SNS registration information and/or SNS functional information. The SNS registration information may represent identity of the target user. The SNS registration information includes but not limited to one of the at least: a name registered in the SNS application, an address information registered in the SNS application, a time information registered in the SNS application, etc. In this embodiment, the SNS functional information may represent social activities of the target user. The SNS functional information includes but not limited to one of the at least: album information of the SNS application, game information of the SNS application, music information of the SNS application, etc.

The outputting module 103 is configured to output SNS information of the target user.

In this embodiment, SNS information of the target user is outputted by the outputting module 103. In this way, the user knows identity of the target user or social activities of the target user.

According to the embodiment of the present disclosure, the above information inquiring apparatus is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired.

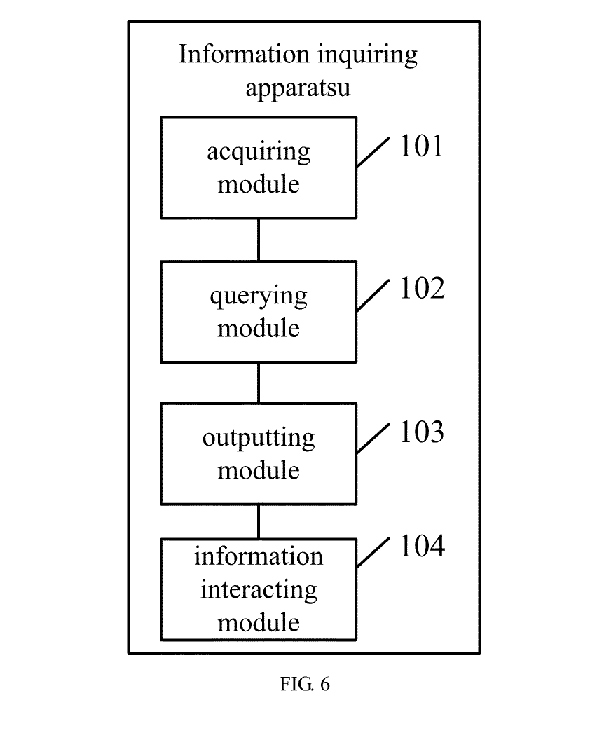

Referring to FIG. 6, information inquiring apparatus in another embodiment is provided. The apparatus includes an acquiring module 101, a querying module 102, an outputting module 103, and an information interacting module 104. The acquiring module 101, the querying module 102, and the outputting module 103 is similar to the one shown in FIG. 5, and will not be further described.

The information interacting module 104 is configured to interact information with the target user according to a social request, when receiving the social request in response to the SNS information of the target user.

In this embodiment, other users can exchange information with the target user. Fox example, other users can initiate a social request, thus inquiring to add the target user as a friend in the SNS application. In one way, the information interacting module 104 sends a social request to the target user. The social request can be a new friend request configured to add a new friend in the SNS application based on the SNS registration information. In another way, the information interacting module 104 sends a social request to the target user, and the social request can be a new friend request configured to ask the target user for taking in a same social activity in the SNS application. In this embodiment, other user sends an invitation request to the target user, based on other user's social request, and based on SNS functional information of the target user. In this way, the SNS application of the target user responses to the invitation request to execute corresponding constructions.

According to this embodiment of the present disclosure, the above information inquiring apparatus is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired. In addition, other users can exchange information with the target user, based on the SNS information, thus on line and off line social relationships can be enhanced, and intelligence of the SNS application is improved.

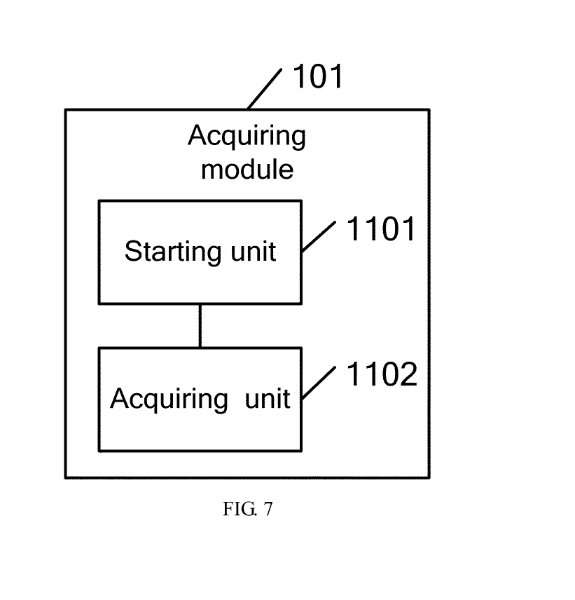

Referring to FIG. 7, an acquiring module 101 in this embodiment is described in details as follow. The acquiring module 101 includes a starting unit 1101 and a capturing unit 1102.

The starting unit 1101 is configured to start a camera application when receiving the query information.

In this embodiment, users can initiate a query information request in an SNS application, if they want to inquire information of the target user. In one embodiment, the user can click on a query information button of an application, or the user can select a certain item in a query information list. Fox example, the information inquiring apparatus is a mobile phone, and if a camera module is embedded in the mobile phone, then a corresponding camera application is initiated by the starting unit 1101, when the query information request is detected. In alternative embodiments, a camera module is not built in the apparatus. Instead, an external camera is connected to a personal computer (PC). In this case, when the query information request initiated by the user is detected, the external camera is started by the starting unit 1101.

The capturing unit 1102 is configured to capture facial image of the target user using the camera application. In this embodiment, a facial image of the target user is captured by the capturing unit 1102. In addition, the facial image can be dynamic image or static image.

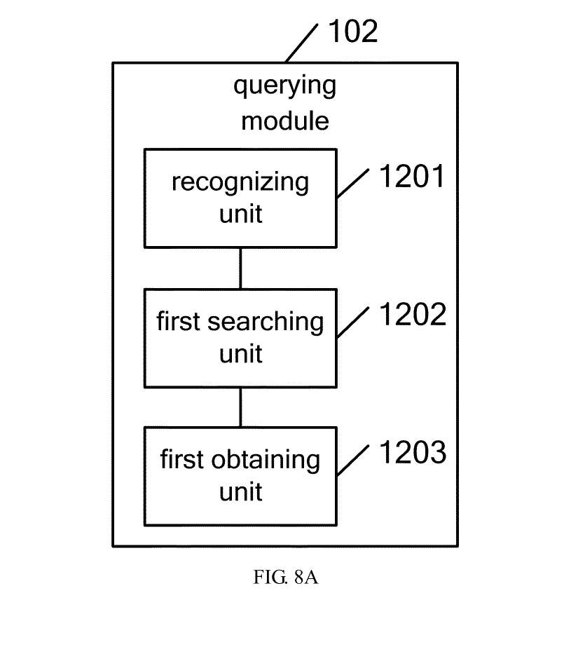

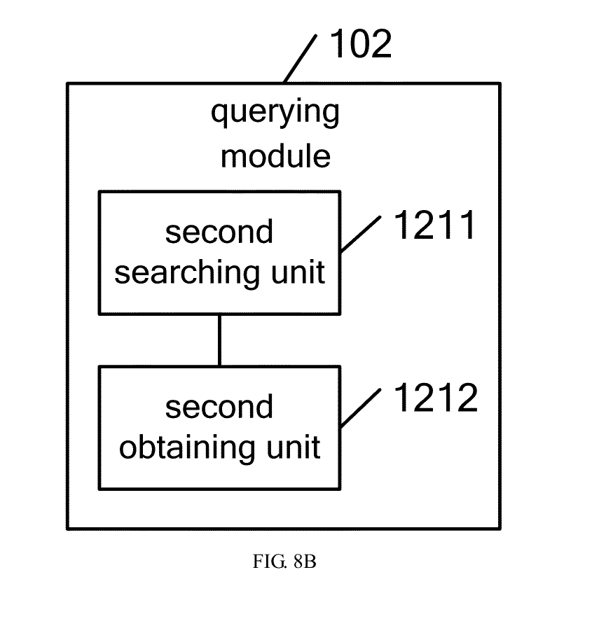

FIG. 8A is a block diagram of a querying module 102 of an apparatus, in accordance with an embodiment of the present disclosure. The querying module 102 includes a recognizing unit 1201, a first searching unit 1202, and a first obtaining unit 1203.

The recognizing unit 1201 is configured to recognize facial features of the target user based on the facial image of the target user.

In this embodiment, the recognizing unit 1201 can recognize facial features of the target user by using human face recognition technology, based on the facial image of the target user.

In a feasible embodiment, the recognizing unit 1201 introduces feature vector method, based on human face recognition technology. The method firstly determines size, location, distance and other characteristics of iris, nose, mouth and other facial features. Then a feature vector of each characteristic is calculated. Amount of the geometric properties of each characteristic constitutes the facial feature vector of the target user, which is configured to describe facial characteristics of the target user.

In another possible embodiment of the present disclosure, the recognizing unit 1201 introduces Face print technology. In this embodiment, a face print file is formed by using sampling and a series of quantization processing based on the target user's facial image. Then a number of face print codes is generated by using the face print file. The face print codes can reflect the target user's facial features. By using the face print codes, shortage of light, skin color, facial hair, hair, glasses, facial expressions and gestures can be eliminated, resulting in high reliability.

It is noted, other methods of human face recognition technology can be introduced by the recognizing unit 1201 to recognize facial features. For example, auto correlation pattern recognition using network or combination of features and template, etc. can also be configured to recognize facial features of the target user.

The first searching unit 1202 is configured to search for feature information matching with the facial features of the target user from a feature database.

The feature database stores at least one user's feature information, and the SNS information corresponding to the feature information of each user. In this embodiment, the feature information of the user refers to information for describing facial feature of the user, includes: feature vectors of the facial image related to the user, and/or face print codes of the user. In addition, the feature information of the user is related to the SNS information of the user. In other words, the SNS information of the user can be searched by using the feature information of the user. In contrary, the feature information of the user can be searched by using the SNS information of the user. In this embodiment, the first searching unit 1202 searches the feature information corresponding to the facial feature of the target user in the feature database, by using the facial feature of the target user. In particular, if the first searching unit 1202 searches the feature information corresponding to the facial feature of the target user, then the feature information is sent to the first obtaining unit 1203, such that the first obtaining unit 1203 can obtain SNS information from the feature information. In contrary, if the feature information corresponding to the facial feature of the target user cannot be searched by the first searching unit 1202, then tips can be displayed to remind query fails.

The first obtaining unit 1203 can be configured to obtain SNS information corresponding to the feature information of the searched user, the SNS information serving as the target user's SNS information.

As described above, the feature database stores at least one user's feature information, and the SNS information corresponding to the feature information of each user. By using the facial feature of the target user, the first obtaining unit 1203 searches the feature information corresponding to the facial feature of the target user in the feature database. And the SNS information of the user can be searched by using the feature information of the user. The SNS information serves as the target user's SNS information.

Referring to FIG. 8B, an information inquiring apparatus in another embodiment is provided. The apparatus includes a second searching unit 1211 and a second obtaining unit 1212.

The second searching unit 1211 is configured to search for user image information matching with the facial image of the target user from an image database.

In this embodiment, the image database stores at least one user's user image information, and the SNS information corresponding to the user image information of each user. In this embodiment, the image information of the user refers to information for describing facial information of the user, such as image information. The image information of the user is related to the SNS information of the user. In other words, the SNS information of the user can be searched by using the image information of the user. In contrary, the image information of the user can be searched by using the SNS information of the user. In this embodiment, by using the facial image of the target user, the second searching unit 1211 searches the image information corresponding to the facial image of the target user in the image database, based on the image matching technique. In particular, if the image information corresponding to the facial image of the target user can be searched by the second searching unit 1211, then the second obtaining unit 1212 is configured to obtain SNS information. In contrary, if the image information corresponding to the facial image of the target user cannot be searched by the second searching unit 1211, then tips can be displayed to remind query fails.

The second obtaining unit 1212 is configured to obtain SNS information corresponding to the image information of the searched user, the SNS information serving as the target user's SNS information.

As described above, the image database stores at least one user's image information, and the SNS information corresponding to the image information of each user. By using the facial image of the target user, the second obtaining unit 1212 searches the image information corresponding to the facial image of the target user in the image database. And the SNS information of the user can be searched by using the image information of the user. The SNS information serves as the target user's SNS information.

The above information inquiring apparatus is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired. In addition, other users can exchange information with the target user, based on the SNS information, thus on line and off line social relationships can be enhanced, and intelligence of the SNS application is improved.

Referring to FIG. 5 to FIG. 8, in a first feasible embodiment of the information inquiring apparatus, the acquiring module 101, the querying module 102, the outputting module 103, and the information interacting module 104 are integrated in the information inquiring apparatus.

In this feasible embodiment, the acquiring module 101, the querying module 102, and the outputting module 103 are integrated in the first configuration device. In addition, the information interacting module 104 is integrated in the second configuration device. The first configuration device and the second configuration device cooperate to form the information inquiring apparatus.

According to various embodiments of the present disclosure, the above information inquiring apparatus is configured to increase efficiency of information queries and improve intelligence of the SNS application, by acquiring facial image of a target user to be inquired when receiving query information request; and by querying social network service information of the target user matching with the facial image, based on the facial image of the target user; and further by outputting social network service information of the target user. In this way, the user can inquire information of the target user easily, free of inputting basic information manually of the user to be inquired.

The apparatus described above according to various embodiments are merely illustrative. The units/modules depicted as separate components may be or may not be physically separated. Components shown as units may be or may not be physical units. That is, they may be located in one place or may be distributed to multiple network units. According to practical needs, part or all of the units/modules can be selected to achieve the purpose according to various embodiments.

The methods and apparatus in accordance with various embodiments can be accomplished using a program/software to instruct related hardware. The hardware can include any suitable universal hardware, or any suitable specialized hardware including, e.g., specialized integrated circuits, specialized central processing unit (CPU), specialized memory, specialized components, etc. For example, the hardware can include personal computer, server, network device, etc. The program/software can be stored in a computer-readable storage medium including, e.g., ROM/RAM, magnetic disk, optical disk, etc.

The embodiments described above are merely preferred ones of the present disclosure but are not limitations to the protection scope of the present disclosure, and any variations or substitutions easily devised by those skilled in the art without departing from the spirit of the present disclosure fall within the scope of the protection. Therefore, the protection scope of the present disclosure shall be subject to that specified by the appended claims.

1. A method for inquiring information, comprising:
acquiring facial image of a target user to be inquired when receiving query information request;
querying social network service information of the target user matching with the facial image, based on the facial image of the target user; and
outputting the social network service information of the target user.

2. The method of claim 1, wherein acquiring facial image of a target user to be inquired when receiving query information request, comprising:
starting a camera application when receiving the query information request; and
capturing the facial image of the target user using the camera application.

3. The method of claim 2, wherein querying social network service information of the target user matching with the facial image, based on the facial image of the target user, comprising:
recognizing facial features of the target user based on the facial image of the target user;
searching for feature information matching with the facial features of the target user from a feature database, wherein the feature database stores at least one user's feature information, and the SNS information corresponding to the feature information of each user; and
obtaining SNS information corresponding to the feature information of the searched user, the SNS information serving as the target user's SNS information.

4. The method of claim 2, wherein querying social network service information of the target user matching with the facial image, based on the facial image of the target user, comprising:
searching for user image information matching with the facial image of the target user from an image database, wherein the image database stores at least one user's user image information, and the SNS information corresponding to the user image information of each user;
obtaining SNS information corresponding to the image information of the searched user.

5. The method of claim 1, wherein after outputting social network service information of the target user, the method further comprising:
interacting information with the target user according to a social request when receiving the social request in response to the SNS information of the target user.

6. An information inquiring apparatus, comprising:
acquiring module, configured for acquiring facial image of a target user to be inquired when receiving query information request;
querying module, configured for querying social network service information of the target user matching with the facial image, based on the facial image of the target user; and
outputting module, configured for outputting social network service information of the target user.

7. The apparatus of claim 6, wherein the acquiring module, comprises:
starting unit, configured for starting a camera application when receiving the query information request; and
capturing unit, configured for capturing facial image of the target user using the camera application.

8. The apparatus of claim 7, wherein the querying module, comprises:
recognizing unit, configured for recognizing facial features of the target user based on the facial image of the target user;
first searching unit, configured for searching for feature information matching with the facial features of the target user from a feature database, wherein the feature database stores at least one user's feature information, and the SNS information corresponding to the feature information of each user;
first obtaining unit, configured for obtaining SNS information corresponding to the feature information of the searched user.

9. The apparatus of claim 7, wherein querying module, comprises:
second searching unit, searching for user image information matching with the facial image of the target user from an image database, wherein the image database stores at least one user's user image information, and the SNS information corresponding to the user image information of each user;
second obtaining unit, configured for obtaining SNS information corresponding to the image information of the searched user, the SNS information serving as the target user's SNS information.

10. The apparatus of claim 6, further comprising:
information interacting module, configured for interacting information with the target user according to a social request when receiving the social request in response to the SNS information of the target user.

11. An information inquiring apparatus, comprising:
memory;
one or more processors; and
one or more modules stored in the memory and configured for execution by the one or more processors, the one or more modules including instructions:
to acquire facial image of a target user to be inquired when receiving query information request;
to query social network service information of the target user matching with the facial image, based on the facial image of the target user; and
to output social network service information of the target user.

12. The apparatus of claim 11, wherein the one or more modules further comprises instructions:
to start a camera application when receiving the query information request; and
to capture facial image of the target user using the camera application.

13. The apparatus of claim 12, wherein the one or more modules further comprises instructions:
to recognize facial features of the target user based on the facial image of the target user;
to search for feature information matching with the facial features of the target user from a feature database, wherein the feature database stores at least one user's feature information, and the SNS information corresponding to the feature information of each user;
to obtain SNS information corresponding to the feature information of the searched user, the SNS information serving as the target user's SNS information.

14. The apparatus of claim 12, wherein the one or more modules further comprises instructions:
to search for user image information matching with the facial image of the target user from an image database, wherein the image database stores at least one user's user image information, and the SNS information corresponding to the user image information of each user;
to obtain SNS information corresponding to the image information of the searched user.

15. The apparatus of claim 11, wherein the one or more modules further comprises instructions:
to interact information with the target user according to a social request when receiving the social request in response to the SNS information of the target user.

16. (canceled)

17. (canceled)

18. (canceled)

19. (canceled)

20. (canceled)

21. The method of claim 2, wherein after outputting social network service information of the target user, the method further comprising:
interacting information with the target user according to a social request when receiving the social request in response to the SNS information of the target user.

22. The method of claim 3, wherein after outputting social network service information of the target user, the method further comprising:
interacting information with the target user according to a social request when receiving the social request in response to the SNS information of the target user.

23. The apparatus of claim 7, further comprising:
information interacting module, configured for interacting information with the target user according to a social request when receiving the social request in response to the SNS information of the target user.

24. The apparatus of claim 8, further comprising:
information interacting module, configured for interacting information with the target user according to a social request when receiving the social request in response to the SNS information of the target user.

25. The apparatus of claim 12, wherein the one or more modules further comprises instructions:
to interact information with the target user according to a social request when receiving the social request in response to the SNS information of the target user.

26. The apparatus of claim 13, wherein the one or more modules further comprises instructions:
to interact information with the target user according to a social request when receiving the social request in response to the SNS information of the target user.
